(19) United States
(12) Patent Application Publication
(10) Pub. No.: US 2025/0130080 A1
(43) Pub. Date: Apr. 24, 2025

(54) LOADING DOCK VEHICLE SENSOR APPARATUS

(71) Applicant: THE CHAMBERLAIN GROUP LLC, OAK BROOK, IL (US)

(72) Inventors: Kevin Andrew Braun, Brookfield, WI (US); Nitin Shrikant Chaphalkar, Buffalo Grove, IL (US); Mark Leo Cypert, West Bend, WI (US); Timothy James Muhl, Singer, WI (US); Nathaniel Jeremy Shoener, Colgate, WI (US)

(21) Appl. No.: 18/914,714

(22) Filed: Oct. 14, 2024

Related U.S. Application Data
(60) Provisional application No. 63/545,072, filed on Oct. 20, 2023.

(51) Int. Cl. G01D 11/30; B65G 69/00

(52) U.S. Cl. CPC G01D 11/30; B65G 69/006

(57) ABSTRACT

A vehicle sensor apparatus including a mounting bracket including a base portion including a mounting portion to mount the mounting bracket to a surface; a first wall portion extending from a first peripheral side of the base portion by a first distance; and a second wall portion extending from a second peripheral side of the base portion by a second distance, the first peripheral side different than the second peripheral side, wherein the base, the first wall portion, and the second wall portion define a compartment; and an object sensor disposed in the compartment and coupled to the base portion at a sensor receiving portion, wherein the mounting bracket is mountable to the surface in at least two orientations, wherein the object sensor is couplable to the mounting bracket in at least two orientations, and wherein a thickness of the object sensor is less than the first and second distances.

### CROSS-REFERENCE TO RELATED APPLICATIONS

The present application claims priority to U.S. Provisional Patent Application Ser. No. 63/545,072 filed on Oct. 20, 2023, the disclosure of which is incorporated by reference herein in its entirety.

### FIELD

The present disclosure relates to object detection systems used to detect objects, such as vehicles. More specifically, the present disclosure relates to vehicle detection systems for detecting vehicles such as trucks and tractor-trailers proximate to a loading dock, and mounting apparatuses for such vehicle detection systems.

### BACKGROUND

Typical loading docks provide an area for trucks and tractor-trailers to back up next to an elevated platform of a building so that cargo can be transferred between the truck and the building through a door opening of the building. Some loading docks include dock levelers positioned in the floor of the elevated platform adjacent the door opening. Dock levelers provide an adjustable bridge or ramp between the elevated platform and an interior of the vehicle. Some loading docks also include vehicle restraint systems mounted on a vertical wall of the loading dock below the door opening. Some vehicle restraint systems include a restraint member, such as a hook, that is operable to engage a portion of the trailer, such as a Rear Impact Guard (RIG). When the restraint member is engaged with the trailer, the vehicle restraint system inhibits movement of the vehicle away from the loading dock. The vehicle restraint system restrains the vehicle such that the vehicle's storage area can be conveniently accessed by personnel and/or equipment associated with loading and unloading operations while the position of the vehicle is maintained relative to the loading dock.

Loading docks may be provided with one or more object sensors, such as one or more vehicle presence sensors, to detect the presence or absence of a vehicle near the loading dock. Detection of the presence of the vehicle can be useful in a number of ways, including for monitoring purposes and for enabling/disabling or otherwise triggering particular functions or features at the loading dock. For example, the detection of the presence of a vehicle by a sensor at the loading dock can be used to notify personnel that a vehicle is arriving to be loaded or unloaded. Similarly, the detection of the absence of a vehicle can alert personnel that a vehicle has departed and is no longer positioned at the dock such that the dock may be prepared for arrival of another vehicle. Furthermore, the detection of the presence of a vehicle by a sensor at the loading dock may automatically cause engagement of the vehicle restraint system with a RIG of the vehicle.

Conventional vehicle presence detection sensors are positioned above a loading dock door, such as mounted to a roof of the building that overhangs the loading dock door. However, it may be difficult to install and subsequently access a vehicle presence sensor above the dock door due to the location and the height of the vehicle presence sensor above the ground. For example, door seals or other structures may be installed above the loading dock door, which complicate access to the area above the loading dock door. As another example, a scissor lift or other equipment may be required to safely position a worker adjacent to the appropriate location to install, service, or maintain the vehicle sensor. Accordingly, installing, calibrating and servicing a vehicle sensor above the door of a loading dock can be relatively time-consuming and difficult.

### BRIEF DESCRIPTION

Aspects and advantages of the invention in accordance with the present disclosure will be set forth in part in the following description, or may be obvious from the description, or may be learned through practice of the technology.

In accordance with one embodiment, a vehicle sensor apparatus is provided. The vehicle sensor apparatus includes a mounting bracket comprising: a base portion including a mounting portion to mount the mounting bracket to a surface and a sensor receiving portion; a first wall portion extending from a first peripheral side of the base portion by a first distance; and a second wall portion extending from a second peripheral side of the base portion by a second distance, the first peripheral side different than the second peripheral side, wherein the base, the first wall portion, and the second wall portion together define a compartment; and an object sensor disposed in the compartment and coupled to the base portion at the sensor receiving portion, wherein the mounting bracket is mountable to the surface in at least two different orientations, wherein the object sensor is couplable to the mounting bracket in at least two orientations, and wherein a thickness of the object sensor is less than the first and second distances.

In accordance with another embodiment, a method of coupling an object sensor to a surface at a loading dock is provided. The method includes identifying a location for coupling the object sensor to the surface, the location spaced apart laterally from a center line of the loading dock at a vertical elevation below a dock leveler disposed at the loading dock; determining an orientation to mount a mounting bracket to the surface at the identified location, the orientation depending on one or more spatial constraints associated with the identified location, wherein the orientation is selectable between at least two different orientations, and wherein a wall portion projecting from a base portion of the mounting bracket is disposed at a top of the mounting bracket in the determined orientation; determining an orientation to couple the object sensor to the mounting bracket based at least in part on the determined orientation of the mounting bracket; coupling the object sensor to the mounting bracket at the determined orientation; and mounting the mounting bracket to the surface at the determined orientation at the identified location.

In accordance with another embodiment, a mounting bracket for coupling an object sensor to a surface at a loading dock is provided. The mounting bracket includes a base portion including a mounting portion to mount the mounting bracket to a surface and a sensor receiving portion; a first wall portion extending from a first peripheral side of the base portion by a first distance; and a second wall portion extending from a second peripheral side of the base portion by a second distance, the first peripheral side different than the second peripheral side, wherein the mounting bracket is mountable to the surface in at least two different orientations with at least one of the first or second wall portions disposed at a vertical elevation above the compartment, wherein the base, the first wall portion, and the second wall portion together define a compartment in which the object sensor is receivable, wherein the compartment is configured to receive the object sensor in at least two orientations, and wherein the first and second distances are greater than a thickness of the received object sensor.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective, schematic view of a loading dock, including a movable barrier and accessory devices, the accessory devices including a vehicle sensor apparatus mounted below the loading dock door opening in accordance with embodiments of the present disclosure.

FIG. 2 is a side perspective view of a vehicle sensor apparatus in accordance with one embodiment in a first mounting orientation, including an object sensor and a mounting bracket.

FIG. 3 is a side elevational view of the vehicle sensor apparatus of FIG. 2 in the first mounting orientation in accordance with embodiments of the present disclosure.

FIG. 4 is a front elevational view of the vehicle sensor apparatus of FIG. 2 in a second mounting orientation in accordance with embodiments of the present disclosure.

FIG. 5 is a front elevational view of the mounting bracket of the vehicle sensor apparatus of FIG. 2 in the first mounting orientation in accordance with embodiments of the present disclosure.

FIG. 6 is a front elevational view of the mounting bracket of FIG. 5 with the mounting bracket in a second mounting orientation turned 90 degrees relative to the first mounting orientation in accordance with embodiments of the present disclosure.

FIG. 7 is an elevational view of a loading dock with the vehicle sensor apparatus of FIG. 2 mounted to an outer wall of the loading dock below a dock leveler of the loading dock for detecting the presence of a vehicle in accordance with embodiments of the present disclosure.

FIG. 8 is a flow chart of a method of coupling an object sensor to a surface of a loading dock in accordance with embodiments of the present disclosure.

### DETAILED DESCRIPTION

In one aspect of the present disclosure, a vehicle sensor apparatus is provided that includes a mounting bracket and an object sensor for being connected to the mounting bracket. The mounting bracket includes a base portion for mounting to a wall or other substantially vertical surface of a loading dock, particularly an exterior portion of the loading dock. The mounting bracket includes one or more wall portions or flanges that extend from the base portion about the object sensor with the object sensor connected to the mounting bracket to protect the object sensor from a vehicle and/or inhibit debris, precipitation, or other objects from falling on the object sensor. The mounting bracket and object sensor have a first configuration wherein the object sensor is connected to the mounting bracket at a first orientation relative to the mounting bracket and a second configuration wherein the object sensor is connected to the mounting bracket at a different, second orientation relative to the mounting bracket. In one embodiment, the object sensor is turned approximately 90 degrees from the first orientation to the second orientation. The vehicle sensor apparatus provides flexibility and customizability during installation of the vehicle sensor apparatus because the mounting bracket can be mounted to the wall of the loading dock in an orientation that best suits the layout of the loading dock and the object sensor can be connected to the mounting bracket in either the first or second configuration based upon the orientation of the mounting bracket.

In one embodiment, the object sensor has a wired connection such as a cable protruding therefrom and the mounting bracket has an opening that receives the cable. The one or more wall portions of the mounting bracket extend about the opening to protect the cable. The opening of the mounting bracket is sized to permit the cable of the object sensor to extend in the opening with the mounting bracket and object sensor in either the first configuration or the second configuration. Because the mounting bracket opening can receive the cable with the object sensor and mounting bracket in either the first or second configuration, the cable may be routed away from the object sensor while being protected by the one or more wall portions in either configuration of the mounting bracket and object sensor.

In one embodiment, the one or more wall portions includes a first elongate wall portion having a first length along the base portion and a second elongate wall portion having a second length along the base portion that extends transverse to the first length. The object sensor may have or otherwise be configured with a lower sensitivity along a first axis of the object sensor and a higher sensitivity along a second axis of the object sensor extending perpendicular to the first axis. The first axis of the object sensor is parallel to the first length and transverse to the second length with the mounting bracket and the object sensor in the first configuration. The first axis of the object sensor is parallel to the second length and transverse to the first length with the mounting bracket and the object sensor in the second configuration. In this manner, the first or second configuration of the mounting bracket and object sensor can be selected to orient the more sensitive second axis vertically to limit detection of vehicles at adjacent loading docks.

In one embodiment, the mounting bracket is made of a sufficiently rigid material to protect the object sensor from a vehicle colliding with or otherwise forcefully contacting the vehicle sensor apparatus, e.g., while the vehicle is backing into the loading dock. The mounting bracket may be made of, for example, a material with a high compressive strength such as metal(s) or alloy(s) of iron, titanium and steel. The mounting bracket may include bends which form and otherwise connect the one or more wall portions to the base portion for transferring an impact force to the base portion and/or the surface to which the base portion is mounted. In one embodiment, the mounting bracket has a unitary, one-piece construction such that the wall portions or flanges are formed by bending edges of the base portion to extend approximately perpendicularly from the surface of the base portion.

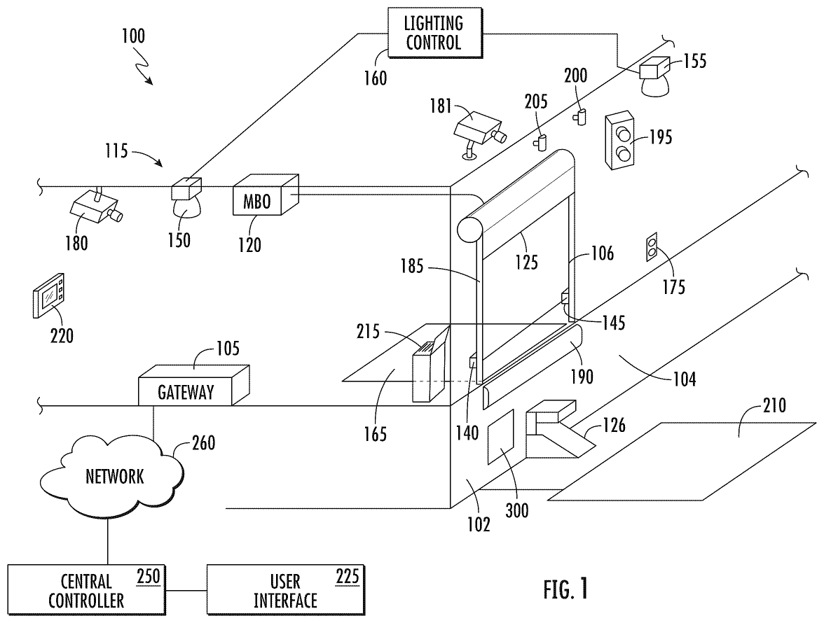

Referring now to the drawings, and in particular to FIG. 1, a vehicle sensor apparatus 300 is provided for detecting the presence or absence of a vehicle near a loading dock 100, such as at the exterior of the loading dock 100. The loading dock 100 includes an outer wall 102 of an elevated platform 104. A vehicle restraint 126 is positioned centrally below a loading dock door opening 106 along the outer wall 102 for operably engaging a bumper or RIG of a truck or trailer that is backed up to the loading dock door opening 106. A dock leveler 165 is installed in the floor of the elevated platform 104 for providing an adjustable bridge or ramp between the elevated platform or a floor of an interior of the loading dock 104 and an interior of a vehicle. The vehicle sensor apparatus 300, described in more detail below, is shown in schematic form and is mounted to the outer wall 102 to one side of the vehicle restraint 126 and below the loading dock door opening 106 and the dock leveler 165.

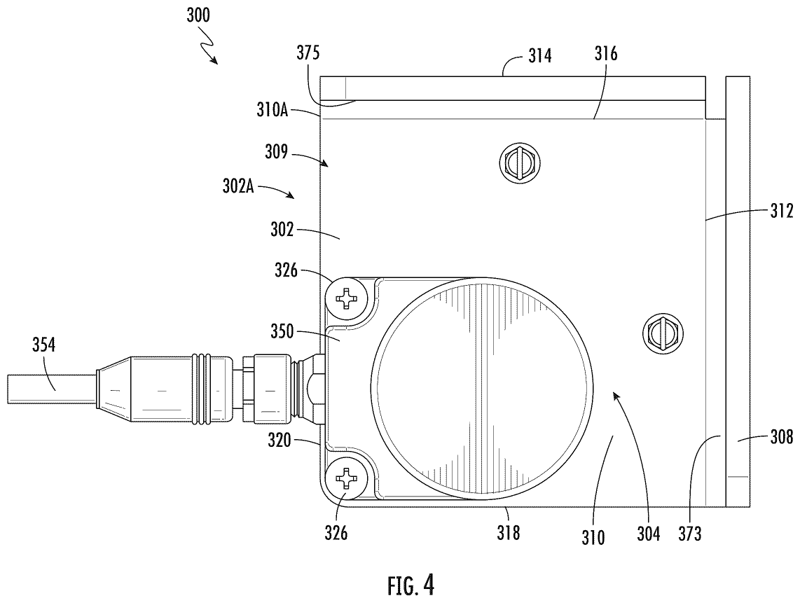

Referring now to FIGS. 2 to 6, the vehicle sensor apparatus 300 includes a mounting bracket 302 and an object sensor 350. The mounting bracket 302 includes a base portion 310 which has an outwardly facing mounting surface 304 configured for mounting the object sensor 350 thereto and an opposite rear surface 306 for being mounted to a surface, such as the outer wall 102 of a loading dock elevated platform 104. The base portion 310 may be polygonal, such as rectangular, circular, or another shape as appropriate. The mounting bracket 302 includes one or more wall portions, such as first and second wall portions 308, 314 upstanding from a periphery 310A of the base portion 310. The first and second wall portions 308, 314 and the base portion 310 cooperate to form a compartment 309 that receives the object sensor 350. In the example of FIG. 4, the base portion 310 is square and the first and second wall portions 308, 314 are upstanding from peripheral sides 312, 316 of the base portion 310. The remaining two peripheral sides 318, 320, of the base portion 310 lack wall portions to provide a peripheral opening 302A of the mounting bracket 302 that extends between the first and second wall portions 308, 314 and provides clearance for a cable 354 of the object sensor 350 to extend therethrough.

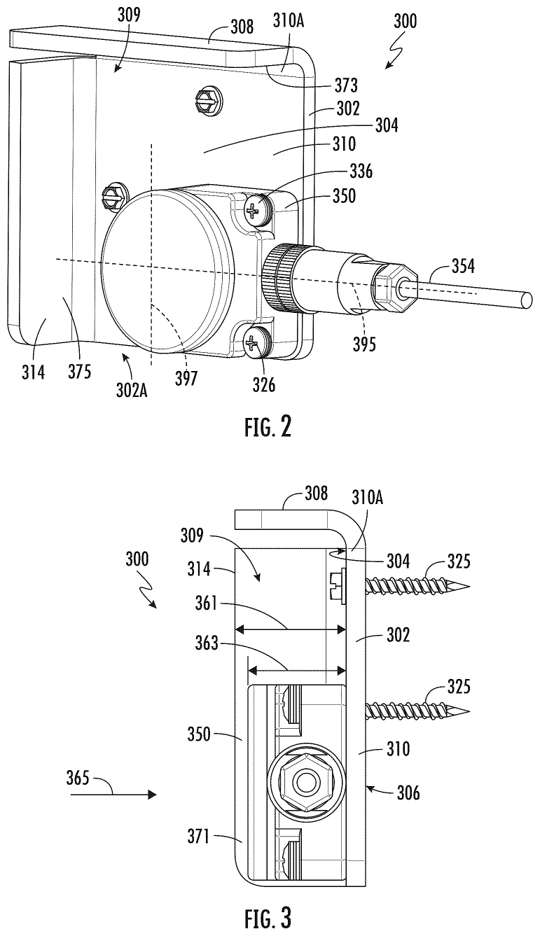

Referring now to FIGS. 3, 5 and 6, the base portion 310 includes a mounting portion, such as two through openings 322, for receiving fasteners such as concrete screws 325 for mounting the mounting bracket 302 to the outer wall 102. Each of the through openings 322 are positioned so as not to interfere with the object sensor 350 and are spaced apart from one another, with one through opening 322 adjacent to the first wall portion 308 and the other through opening 322 adjacent to second wall portion 314. In other embodiments the mounting portion may include a substantial surface area of the rear surface 306 having an adhesive applied thereto. The base portion 310 also includes a sensor receiving portion, such as three smaller, spaced apart through openings 324A, 324B, 324C for mounting the object sensor 350 to the mounting bracket 302 with a pair of mounting screws 326 (FIG. 4). The smaller through openings 324A, 324B, 324C are tapped for mating with threads of the mounting screws 326.

The mounting bracket 302 is configured to allow mounting of the vehicle sensor apparatus 300 in a plurality of configurations, such as a first mounting configuration shown, for example, in FIGS. 2, 3, and 5 where the first wall portion 308 is horizontal and the second wall portion 314 is vertical relative to the loading dock door opening 106. The peripheral opening 302A of the mounting bracket 302 is sized to permit the cable 354 to extend away from the object sensor 350 in a direction perpendicular to the second wall portion 314 with the vehicle sensor apparatus 300 in the first configuration (see FIG. 3). As shown in FIG. 2, the cable 354 extends from the peripheral opening 302A to the right side as viewed from the exterior of the loading dock 100 such that the cable 354 may connect with a terminal or equipment that is located on the right side of the loading dock 100.

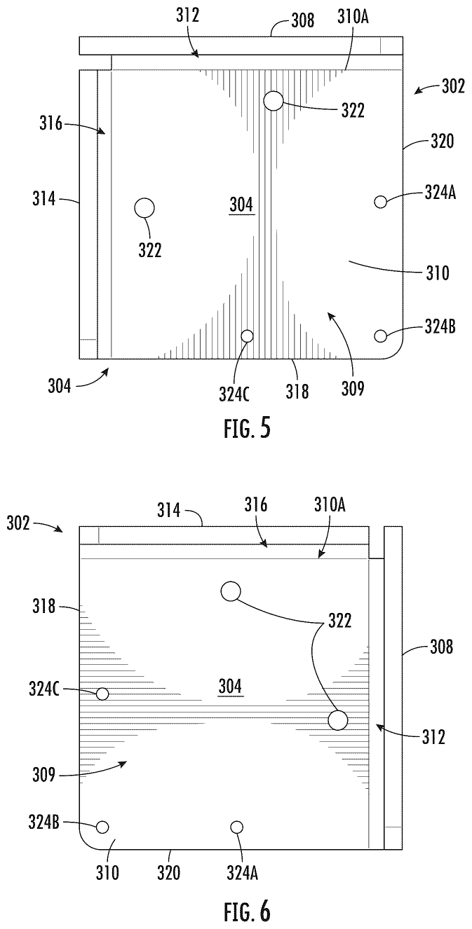

The mounting bracket 302 also allows mounting of the vehicle sensor apparatus 300 in a second configuration wherein the mounting bracket 302 has an orientation as shown, for example, in FIGS. 4 and 6. In the second configuration of the vehicle sensor apparatus 300, the mounting bracket 302 is turned 90 degrees from an orientation of the mounting bracket 302 in FIG. 5, such that the first wall portion 308 is vertical and the second wall portion 314 is horizontal relative to the loading dock door opening 106. The peripheral opening 302A of the mounting bracket 302 is sized to permit the cable 354 to extend away from the object sensor 350 in a direction perpendicular to the first wall portion 308. That is, as shown in FIG. 4, the cable 354 extends from the peripheral opening 302A to the left side as viewed from the exterior of the loading dock 100 such that the cable 354 may connect with a terminal or equipment that is located on the left side of the loading dock 100.

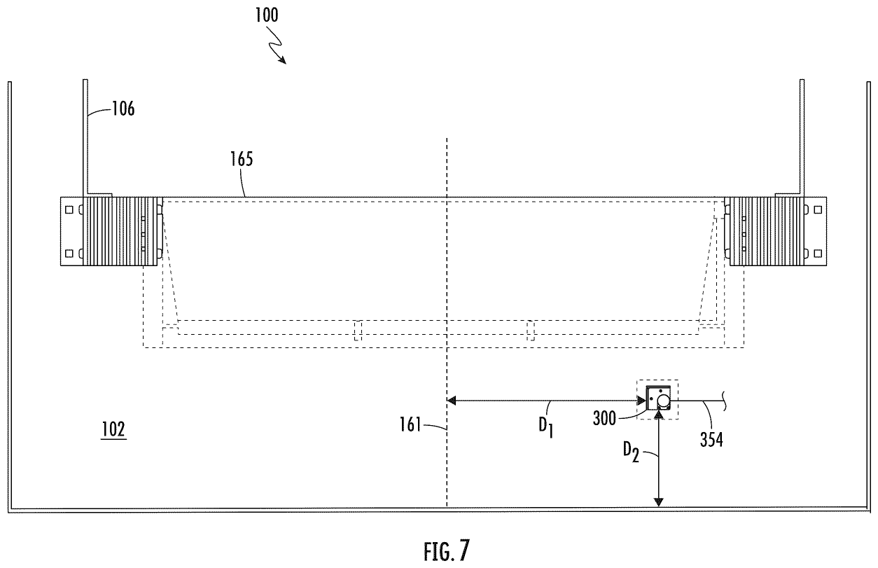

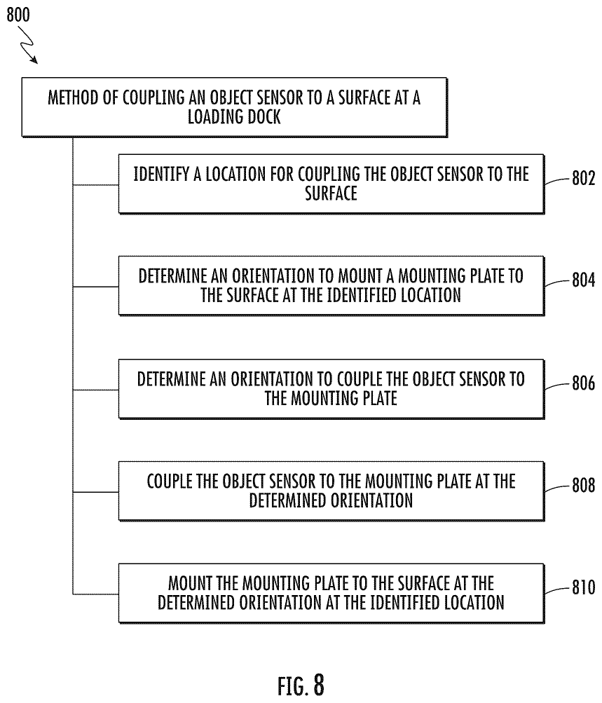

Because the vehicle sensor apparatus 300 can be mounted to the outer wall 102 in a plurality of configurations, the vehicle sensor apparatus 300 provides flexibility for mounting the vehicle sensor apparatus 300 at a particular location on the outer wall 102 according to user preference, avoiding structures that could interfere with the operation of the object sensor 350, and/or the desired routing of cable 354 such as to a junction box. For example, as shown in FIG. 7, the vehicle sensor apparatus 300 is mounted to outer wall 102 in the first mounting orientation on the right side of the center line 161 of the loading dock door opening 106 such that the cable 354 of the object sensor 350, which provides power and facilitates communication between the object sensor 350 and a user interface device 215 (FIG. 1) such as a control panel, extends to the right. Although not shown in FIG. 7, typically a vehicle restraint 126 is positioned centrally underneath the loading dock door opening 106 as shown in FIG. 1 such that the vehicle sensor apparatus 300 is positioned to one side thereof. In one embodiment, the vehicle sensor apparatus 300 is positioned a distance D₁ between about 30 to about 34 inches from the center line 161 to avoid interference with the vehicle restraint 126 and a distance D₂ of approximately 20 inches above the ground to maximize effectiveness of the object sensor 350, although other positions may be used depending on the particular arrangement of the loading dock 100 and the accessory devices 115 thereof.

Referring now to FIGS. 2 and 5, when vehicle sensor apparatus 300 is in the first mounting configuration, the object sensor 350 is mounted to the outwardly facing mounting surface 304 with a pair of mounting screws 326 received in the corresponding two openings 324A, 324B and the opening 324C is not used. The first mounting configuration of the vehicle sensor apparatus 300 may be used when the vehicle sensor apparatus 300 is to be mounted on the right side of the center line 161 in FIG. 7.

If the vehicle sensor apparatus 300 is to be mounted on the left side of the center line 161 (see FIG. 7) of the loading dock door opening 106, typically the second configuration of the vehicle sensor apparatus 300 with the mounting bracket 302 in the orientation shown in FIG. 6 will be preferable to allow the cable 354 to be routed to the left of the vehicle sensor apparatus 300. When the mounting bracket 302 is in the second mounting orientation shown in FIG. 6, the object sensor 350 is secured to the outwardly facing mounting surface 304 of the mounting bracket 302 with the pair of mounting screws 326 received in the openings 324B, 324C and the opening 324A is not used.

When the vehicle sensor apparatus 300 is mounted to the outer wall 102 of the loading dock 100 under the movable barrier 125, it is possible that a portion of a vehicle, such as a RIG of a trailer, may contact the vehicle sensor apparatus 300 when backing up to the loading dock 100. Further, objects and debris can fall from above, such as during loading and unloading of a vehicle. In addition, as the mounting location is typically outside and exposed to the weather, snow and ice may accumulate on the object sensor 350. Accordingly, the mounting bracket 302 is configured to protect the object sensor 350 from damage or malfunction due to impacts and additionally to shield the object sensor 350 from falling debris and the accumulation of snow and ice on the object sensor 350. Regarding FIG. 5, the first wall portion 308 of the mounting bracket 302 extends transversely with respect to the outwardly facing mounting surface 304 from one peripheral side 312 of the base portion 310. Likewise, the second wall portion 314 extends transversely with respect to the outwardly facing mounting surface 304 from the peripheral side 316 of the base portion 310. Each of the respective peripheral sides 318, 320 (which are opposed to the respective peripheral sides 312, 316) of the base portion 310 lack transversely extending wall portions to allow cable 354 to be connected to a cable connector port extending generally from a lower side of the object sensor 350 (which in FIG. 2 is oriented horizontally to the right due to the horizontal orientation of the object sensor), whether the vehicle sensor apparatus 300 is in the first or the second configuration. In the first configuration shown in FIG. 2, the first wall portion 308 is positioned above the object sensor 350 and protects the object sensor 350 against falling objects and debris, as well as vehicle impacts, and the second wall portion 314 provides additional protection against vehicle impacts. In one embodiment, the mounting bracket 302 is manufactured by stamping or otherwise providing an L-shaped plate and bending or forming the first and second wall portions 308, 314 out of the plane of the base portion 310. In FIGS. 2-6, the first and second wall portions 308, 314 are normal to the base portion 310.

Regarding FIG. 3, the first and second wall portions 308, 314 are preferably sized to extend outward from the outwardly facing mounting surface 304 a distance 361 measured orthogonally to the outwardly facing mounting surface 304 that is greater than a thickness 363 of the object sensor 350, such that the object sensor 350 is protected by the first and/or second wall portions 308, 314 against impacts in direction 365. Further, the first wall portion 308 provides an overhang that directs falling snow and ice away from the object sensor 350 when the vehicle sensor apparatus 300 is in the first configuration of FIG. 3. The second wall portion 314 provides an overhang that directs falling snow and ice away from the object sensor 350 when the vehicle sensor apparatus 300 is in the second configuration. The first and second wall portions 308, 314 may be sized so as not to interfere with the signal emitted by the object sensor 350, such as a radar signal. In one form, the wall portions 308, 314 extend beyond an outermost portion 371 of the object sensor 350 by approximately 0.125 inch. In addition, referring to FIG. 2, in one embodiment an interior surface 373 of the first wall portion 308 has a minimum distance from the object sensor 350 of approximately 1.5 inches and the interior surface 375 of second wall portion 314 has a minimum distance from the object sensor 350 of approximately 1.25 inches to provide sufficient protection for the object sensor 350 while limiting interference with the signal emitted by the object sensor 350. In an embodiment, the first wall portion 308 extends a first distance from the outwardly facing mounting surface 304 and the second wall portion 308 extends a second distance from the outwardly facing mounting surface 304, where the first and second distances are different from one another. The first and second distances can both be greater than the thickness 363 of the object sensor 350.

The object sensor 350 may include one or more types of sensors, such as active infrared, passive infrared, ultrasonic, radar, microwave, laser, electromagnetic induction, ultra-IR LED, time-of-flight pulse ranging technology, photoelectric eye, thermal image, video analytics, AI-based image analysis cameras and/or any combination(s) thereof. In one embodiment, the object sensor 350 is a radar sensor such as a K50R Series radar sensor available from Banner Engineering Corp. The object sensor 350 has a narrower range or sensitivity along a first axis 395 and a wider range or sensitivity along a perpendicular, second axis 397 as shown in FIG. 2. In one embodiment, the object sensor 350 has a generally elliptical cone-shaped beam pattern or field of view that extends outwardly from an emitter of the object sensor 350 at approximately a 60 degree angle along the first axis 395 and approximately an 80 degree angle along the second axis 397. The object sensor 350 is mounted horizontally, such that the narrower range or sensitivity of the object sensor 350 along first axis 395 is also oriented horizontally. This orientation has been discovered to allow for more accurate detection of vehicles by minimizing false readings caused by vehicles located at adjacent loading docks on either side of loading dock 100. In one embodiment, the radar sensor is configured and/or programmed to sense objects at a distance from 1.5 to 2.6 meters.

The vehicle sensor apparatus 300 is operable to detect the presence or absence of a vehicle and may be operable to activate or allow operation of, or deactivate or disallow operation of, certain equipment, such as a dock leveler, a vehicle restraint, and/or an overhead door.

As mentioned above and referring again to FIG. 1, the vehicle sensor apparatus 300 is operably connected with the user interface device 215, which may be configured to control one or more additional accessory devices 115. The user interface device 215 may be temporarily or permanently mounted near a given movable barrier 125 or may be configured as a portable user interface 220 that can be carried around a dock 100 so as to control accessory devices 115 (such as object sensor 350) at more than one loading dock 100. Another option includes running a user interface application on a separate general purpose computing device such as a smart phone, tablet computer, or other portable device.

The user interface device 215 may also be operably connected with a gateway 105, for allowing remote monitoring and/or operation of the loading dock 100 by a central controller 250 and/or user interface 225 via a network 260. The gateway 105 may be configured to communicate using wired or wireless approaches with one or more accessory devices 115 associated with a movable barrier operator 120. The movable barrier operator 120 is operatively connected to a movable barrier 125, such as a rolling door, to move the movable barrier 125 between an open position and a closed position.

Non-limiting examples of the accessory devices 115 include a photoeye 140, safety edge 145, a dock light 150, an exterior controlled light 155, a lighting control 160, a dock leveler 165, a vehicle restraint 126, a controlled power outlet 175, one or more cameras 180 and 181, a dock seal 185, a dock bumper 190, a dock stoplight 195, a microwave sensor 200, an area optical detector 205, a loop detector 210, and the vehicle sensor apparatus 300. The microwave sensor 200, area optical detector 205, and loop detector 210 may be utilized in some embodiments to supplement vehicle detection using the vehicle sensor apparatus 300.

FIG. 8 illustrates a flow chart of a method 800 of coupling an object sensor to a surface at a loading dock in accordance with an example embodiment. In general, the method 800 will be described with reference to a system including the vehicle sensor apparatus 300 described above with respect to FIGS. 1 to 7, however, the method 800 may be implemented with yet other types of systems. In addition, although FIG. 8 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

The method 800 includes identifying 802 a location for coupling an object sensor to a surface at a loading dock. Identification 802 of the location for coupling the object sensor the surface may be performed, for example, by an installation technician. The installation technician may approach the loading dock straight on (i.e., facing the loading dock). Reference to directions is made with respect to this approach angle.

The loading dock generally defines a center line extending vertically and bifurcating the loading dock into two halves-a left half and a right half. The technician identifies 802 a location laterally offset from the center line, i.e., in one of the left half or the right half. The technician may mark a lateral offset from the center line, for example, in a range of 15 inches and 40 inches, and more particularly in a range of 30 inches and 34 inches. The technician can then identify a height, e.g., as measured from a ground location below the loading dock opening, at which to locate the object sensor. The height may be in a range of, for example, 10 inches and 30 inches, such as in a range of 18 inches and 22 inches. In some instances, the height of the location may also be considered in view of the loading dock floor, e.g., a dock leveler or the like. For example, the location can be determined at least partially based on a vertical elevation from the dock leveler in a downward direction. The technician may also determine the location in view of equipment present at the loading dock bay. For example, different equipment can mandate different locations for coupling the object sensor to the surface in order to maximize sensor efficiency. After locating the appropriate height for mounting the object sensor to the surface, the technician can mark the determined height. Using the determined lateral offset and the determined height, the technician has identified 802 the location for coupling the object sensor to the surface of the loading dock. In some instances, the technician can mark the location, e.g., using a marker, a stencil, tape, or the like.

Determining the lateral offset and height of the location may be performed in view of one or more factors. These factors can include, sensor-specific characteristics, such as viewing angle, detection distance, cable length, etc.; loading dock specific characteristics, such as layout, distance between adjacent loading dock bays, slope of the ground underyling the loading dock, distance from the loading dock directly outward to a nearest surface (e.g., a gate or wall), etc.; or any one or more other considerations or factors associated with properly detecting vehicles at the loading dock.

The method 800 further includes determining 804 an orientation to mount a mounting bracket to the surface at the identified location. The orientation can depend on one or more spatial constraints associated with the identified location. For example, the object sensor may include a cable that transmits signals to nearby systems and circuitry. The location of the nearby systems and circuitry may require routing of the cable in a particular direction. The orientation of the mounting bracket may vary based on the direction the cable needs to be routed in order to communicate with the nearby systems and circuitry. In some instances, routing is leftward. In other instances, routing is rightward. In some instances, the cable must cross over the center line of the loading dock. In other instances, the cable does not cross over the center line of the loading dock. Preferably, the cable is routed in a direction, and the location for coupling the object sensor to the surface is identified 802, in view of not passing the cable over the center line of the loading dock as the center line already exhibits high volumes of equipment, such as trailer restraint features that engage, e.g., with trailer RIGs. Additionally, shorter runs of cable pose reduced distances of environmental exposure where the cable might become impacted by accessory equipment, e.g., during snow removal operations or the like. As depicted in FIG. 7, the cable 354 is routed to a right side of the loading dock away from the center line. In some implementations, the technician may be required to drill a hole into the sidewall of the loading dock facility to pass the cable through the sidewall and into communication with one or more internally-located systems or circuitry. In other implementations, the direction of the cable can be determined in view of already-present holes or access points within the sidewall that permit routing of the cable into the sidewall of the facility. In some instances, adjacent loading dock bays can share cable routing passageways. For example, first and second neighboring loading dock bays can a share cable passageway. In this regard, the object sensors of the respective first and second neighboring loading dock bays can be configured in the inverse orientation as compared to one another, i.e., with a left loading dock bay having a right-exiting cable and a right loading dock bay having a left-exiting cable that both pass through a common passageway disposed at least partially between the left and right loading dock bays.

The determined 804 orientation can be made such that one or more wall portions, such as wall portion 308 or 314 (FIG. 2) is disposed at a vertical elevation above the base portion, such as base portion 310. In this regard, the upper wall portion can protect the object sensor against environmental debris, such as rain, snow, and sleet, and objects which might fall from the loading dock bay, such as cargo, strapping, or the like. The mounting bracket can be spatially configured such that in any orientation of the mounting bracket, a wall portion is disposed at the top of the base portion 310.

The orientation of the mounting bracket may position the wall portions in rectilinear alignment with features of the loading dock. For example, at least one of the wall portions can be vertically oriented and at least one of the wall portions can be horizontally oriented. Placement of the wall portions in horizontal and vertical orientations may suitably protect the object sensor and prevent impact therewith, such as for example, when a trailer is backing into the loading dock bay and comes into contact with the mounting bracket. Horizontal elements of the trailer will impact against the vertical wall portion and vertical elements of the trailer will impact against the horizontal wall portion. In this regard, the object sensor remains protected against damage from the trailer in addition to aforementioned environmental damage.

Determining 804 the orientation may be performed in advance, i.e., prior to the technician arriving at the loading dock bay. Alternatively, or additionally, the determination 804 may be at least partially performed in view of the technician's assessment of the loading dock bay.

The method 800 can further include determining 806 an orientation to couple the object sensor the mounting bracket. The determined 806 orientation can be performed in view of the aforementioned cable constraints. For example, where the cable exits to the right, the object sensor is mounted in a particular orientation such that the cable exits or extends from a right side of the object sensor. In this regard, cable does not wind within the mounting bracket where it can become damaged and the cable length is reduced to a shortest length possible to further mitigate environmental exposure and potential damage.

In some instances, determining 806 the orientation to couple the object sensor to the mounting bracket is performed prior to determining 804 the orientation to mount the mounting bracket to the surface. In some instances, determining 804 the orientation to mount the mounting bracket to the surface is performed at least in part based on a determined orientation to couple the object sensor to the surface.

The method 800 can further include coupling 808 the object sensor to the mounting bracket at the determined orientation and mounting 810 the mounting bracket to the surface at the determined orientation at the identified location.

As described above, the mounting bracket can protect the object sensor from environmental damage and mitigate impacts against the object sensor from RIGs associated with the trailer or other trailer features or components. Moreover, the mounting bracket can mitigate damage associated with impact from other accessory equipment like snow removal equipment (e.g., snow plows) which might pass in close proximity to the loading dock to assist in snow removal. The wall portions of the mounting bracket can mitigate damage by forming a protective compartment in which the object sensor resides. The wall portions extend further from the base portion than the object sensor such that impact initially occurs along a leading edge of the wall portions and is absorbed by the mounting bracket without being transferred to the object sensor. In some implementation, the portion of the base portion to which the object sensor is coupled can be isolated, or at least partially isolated, from the peripheral edge of the base portion such that deformation of the mounting bracket resulting from impact against the wall portions does not cause deformation to locations of the base plate to which the object sensor is coupled. In some instances, this can be accomplished by forming the base portion from two separate pieces-a first piece to which the object sensor is coupled and a second piece which is coupled to the first piece and which includes the wall portions. In another embodiment, the first and second pieces can be a single piece with a frangible portion therebetween. The frangible portion can deform or otherwise accept deformation prior to transferring deformation to the location of the base portion to which the object sensor is coupled.

In an embodiment, the mounting bracket can be separated or interposed from the sidewall by a sensor mounted, e.g., to a rear surface of the mounting bracket. The sensor can be, for example, a pressure sensor that senses a force between the mounting bracket and the sidewall. The sensor can detect, for example, when the trailer impacts the mounting bracket and transmit signals to circuitry indicative of the impact. The circuitry may include, for example, local equipment and/or a remote server. The circuitry can compare the received signals from the sensor, for example to a lookup table or against a threshold value, and determine the nature of impact exhibited on the mounting bracket. Where a threshold value is used for the comparison, the threshold value may correspond to a deformation threshold of the mounting bracket. For example, the threshold value can be set at or near a deformation threshold of the mounting bracket. Thus, when the mounting bracket, and more specifically the wall portions of the mounting bracket, are impacted by a force exceeding the threshold value, the circuitry can determine damage likely occurred to the mounting bracket. The circuitry can then generate a notification and/or a warning. The notification may be transmitted, for example, to onsite personnel that can assess the damage. The notification may further be transmitted to a driver associated with the trailer. For example, the notification may be transmitted as a text message to the driver. The notification can signal for the driver to move the vehicle away from the loading dock. The driver can move away from the loading dock in response to receiving the notification to allow the onsite personnel to assess the damage. Alternatively, or additionally, the notification can cause the loading dock to enter a maintenance phase in which the loading dock bay is, for example, taken offline and further scheduling operations at that loading dock bay are cancelled or moved to other loading dock bays.

Further aspects of the invention are provided by one or more of the following embodiments:

Embodiment 1. A vehicle sensor apparatus comprising: a mounting bracket comprising: a base portion including a mounting portion to mount the mounting bracket to a surface and a sensor receiving portion; a first wall portion extending from a first peripheral side of the base portion by a first distance; and a second wall portion extending from a second peripheral side of the base portion by a second distance, the first peripheral side different than the second peripheral side, wherein the base, the first wall portion, and the second wall portion together define a compartment; and an object sensor disposed in the compartment and coupled to the base portion at the sensor receiving portion, wherein the mounting bracket is mountable to the surface in at least two different orientations, wherein the object sensor is couplable to the mounting bracket in at least two orientations, and wherein a thickness of the object sensor is less than the first and second distances.

Embodiment 2. The vehicle sensor apparatus of embodiment 1, wherein the first and second peripheral sides of the base portion are consecutively arranged, wherein the base portion further comprises a third peripheral side and a fourth peripheral side, and wherein the third and fourth peripheral sides terminate without wall portions.

Embodiment 3. The vehicle sensor apparatus of embodiment 2, wherein the mounting bracket is mounted to the surface with at least one of the first or second wall portions disposed at a vertical elevation above the object sensor.

Embodiment 4. The vehicle sensor apparatus of embodiment 2, wherein the object sensor comprises a cable that provides power to the object sensor and facilitates communication between the object sensor and a user interface device, and wherein the cable extends from the sensor and traverses one of the third or fourth peripheral sides of the base portion.

Embodiment 5. The vehicle sensor apparatus of any one or more of embodiments 1 to 4, wherein the mounting bracket comprises a single-piece construction, and wherein the first and second wall portions are bent from the base portion by a stamping process.

Embodiment 6. The vehicle sensor apparatus of any one or more of embodiments 1 to 5, wherein the mounting portion comprises a non-threaded opening, and wherein the sensor receiving portion comprises a threaded through opening.

Embodiment 7. The vehicle sensor apparatus of embodiment 6, wherein the threaded through opening comprises three threaded through openings, wherein the object sensor is only coupled to two of the three threaded through openings, and wherein the relative orientation of the object sensor with respect to the mounting portion is determined by which two of the three threaded through openings are used to couple the object sensor to the mounting portion.

Embodiment 8. The vehicle sensor apparatus of any one or more of embodiments 1 to 7, wherein the object sensor comprises a first sensitivity along a first axis of detection and a second sensitivity along a second axis of detection perpendicular to the first axis of detection, wherein the first sensitivity is less than the second sensitivity, and wherein the first axis is a horizontal axis.

Embodiment 9. A method of coupling an object sensor to a surface at a loading dock, the method comprising: identifying a location for coupling the object sensor to the surface, the location spaced apart laterally from a center line of the loading dock at a vertical elevation below a dock leveler disposed at the loading dock; determining an orientation to mount a mounting bracket to the surface at the identified location, the orientation depending on one or more spatial constraints associated with the identified location, wherein the orientation is selectable between at least two different orientations, and wherein a wall portion projecting from a base portion of the mounting bracket is disposed at a top of the mounting bracket in the determined orientation; determining an orientation to couple the object sensor to the mounting bracket based at least in part on the determined orientation of the mounting bracket; coupling the object sensor to the mounting bracket at the determined orientation; and mounting the mounting bracket to the surface at the determined orientation at the identified location.

Embodiment 10. The method of embodiment 9, wherein coupling the object sensor to the mounting bracket comprises threading two fasters through the object sensor into two threaded through openings in the base portion of the mounting bracket, and wherein the base portion comprises three threaded through openings, one of which is not used depending on the determined orientation of the object sensor relative to the mounting bracket.

Embodiment 11. The method of any one or more of embodiments 9 or 10, further comprising attaching the object sensor to a user interface device through a cable by routing the cable from the object sensor in a direction away from the wall portion.

Embodiment 12. The method of any one or more of embodiments 9 to 11, wherein the mounting bracket comprises a first wall portion and a second wall portion, each of the first and second wall portions extending from a peripheral side of the base portion of the mounting bracket, and wherein coupling the object sensor to the mounting bracket is performed such that the object sensor is protected by the first and second wall portions against lateral impact from a rear impact guard (RIG) of a trailer approaching the loading dock.

Embodiment 13. The method of any one or more of embodiments 9 to 12, wherein the object sensor comprises a first sensitivity along a first axis of detection and a second sensitivity along a second axis of detection perpendicular to the first axis of detection, wherein the first sensitivity is less than the second sensitivity, and wherein determining the orientation to couple the object sensor to the mounting bracket is performed such that the first axis is a horizontal axis.

Embodiment 14. The method of any one or more of embodiments 9 to 13, wherein the object sensor detects presence of a vehicle at the loading dock, and wherein detection signals generated by the object sensor are configured to activate or allow operation of, or deactivate or disallow operation of, one or more equipment at the loading dock.

Embodiment 15. A mounting bracket for coupling an object sensor to a surface at a loading dock, the mounting bracket comprising: a base portion including a mounting portion to mount the mounting bracket to a surface and a sensor receiving portion; a first wall portion extending from a first peripheral side of the base portion by a first distance; and a second wall portion extending from a second peripheral side of the base portion by a second distance, the first peripheral side different than the second peripheral side, wherein the mounting bracket is mountable to the surface in at least two different orientations with at least one of the first or second wall portions disposed at a vertical elevation above the compartment, wherein the base, the first wall portion, and the second wall portion together define a compartment in which the object sensor is receivable, wherein the compartment is configured to receive the object sensor in at least two orientations, and wherein the first and second distances are greater than a thickness of the received object sensor.

Embodiment 16. The mounting bracket of embodiment 15, wherein the mounting portion comprises two unthreaded openings, wherein the sensor receiving portion comprises three threaded openings, and wherein only two of the three threaded openings are used to couple the object sensor to the mounting bracket, the used two threaded openings determined based on the orientation of the object sensor with respect to the base portion.

Embodiment 17. The mounting bracket of embodiment 16, wherein the two unthreaded openings are exposed and accessible from the object sensor when the object sensor is coupled to the mounting bracket.

Embodiment 18. The mounting bracket of embodiment 17, wherein all three of the three threaded openings are covered by the object sensor when the object sensor is coupled to the mounting bracket.

Embodiment 19. The mounting bracket of embodiment 18, wherein the first and second peripheral sides of the base portion are consecutively arranged, wherein the base portion further comprises a third peripheral side and a fourth peripheral side, and wherein the third and fourth peripheral sides terminate without wall portions.

Embodiment 20. A loading dock comprising: a centerline associated with a door of the loading dock; a dock leveler; a sidewall surface disposed below the dock leveler; and the mounting bracket of embodiment 19 disposed laterally offset from the centerline at a location along the sidewall surface below the dock leveler.

While there have been illustrated and described particular embodiments of the present invention, those skilled in the art will recognize that a wide variety of modifications, alterations, and combinations can be made with respect to the above described embodiments without departing from the scope of the disclosure, and that such modifications, alterations, and combinations are to be viewed as being within the ambit of the inventive concept. For example, although the vehicle sensor apparatus described herein has particular application for detecting vehicles, such application is merely illustrative, and many other non-vehicle objects may be detected therewith.

What is claimed is:

1. A vehicle sensor apparatus comprising:
a mounting bracket comprising:
a base portion including a mounting portion to mount the mounting bracket to a surface and a sensor receiving portion;
a first wall portion extending from a first peripheral side of the base portion by a first distance; and
a second wall portion extending from a second peripheral side of the base portion by a second distance, the first peripheral side different than the second peripheral side,
wherein the base, the first wall portion, and the second wall portion together define a compartment; and
an object sensor disposed in the compartment and coupled to the base portion at the sensor receiving portion,
wherein the mounting bracket is mountable to the surface in at least two different orientations, wherein the object sensor is couplable to the mounting bracket in at least two orientations, and wherein a thickness of the object sensor is less than the first and second distances.

2. The vehicle sensor apparatus of claim 1, wherein the first and second peripheral sides of the base portion are consecutively arranged, wherein the base portion further comprises a third peripheral side and a fourth peripheral side, and wherein the third and fourth peripheral sides terminate without wall portions.

3. The vehicle sensor apparatus of claim 2, wherein the mounting bracket is mounted to the surface with at least one of the first or second wall portions disposed at a vertical elevation above the object sensor.

4. The vehicle sensor apparatus of claim 2, wherein the object sensor comprises a cable that provides power to the object sensor and facilitates communication between the object sensor and a user interface device, and wherein the cable extends from the sensor and traverses one of the third or fourth peripheral sides of the base portion.

5. The vehicle sensor apparatus of claim 1, wherein the mounting bracket comprises a single-piece construction, and wherein the first and second wall portions are bent from the base portion by a stamping process.

6. The vehicle sensor apparatus of claim 1, wherein the mounting portion comprises a non-threaded opening, and wherein the sensor receiving portion comprises a threaded through opening.

7. The vehicle sensor apparatus of claim 6, wherein the threaded through opening comprises three threaded through openings, wherein the object sensor is only coupled to two of the three threaded through openings, and wherein the relative orientation of the object sensor with respect to the mounting portion is determined by which two of the three threaded through openings are used to couple the object sensor to the mounting portion.

8. The vehicle sensor apparatus of claim 1, wherein the object sensor comprises a first sensitivity along a first axis of detection and a second sensitivity along a second axis of detection perpendicular to the first axis of detection, wherein the first sensitivity is less than the second sensitivity, and wherein the first axis is a horizontal axis.

9. A method of coupling an object sensor to a surface at a loading dock, the method comprising:
identifying a location for coupling the object sensor to the surface, the location spaced apart laterally from a center line of the loading dock at a vertical elevation below a dock leveler disposed at the loading dock;
determining an orientation to mount a mounting bracket to the surface at the identified location, the orientation depending on one or more spatial constraints associated with the identified location, wherein the orientation is selectable between at least two different orientations, and wherein a wall portion projecting from a base portion of the mounting bracket is disposed at a top of the mounting bracket in the determined orientation;
determining an orientation to couple the object sensor to the mounting bracket based at least in part on the determined orientation of the mounting bracket;
coupling the object sensor to the mounting bracket at the determined orientation; and
mounting the mounting bracket to the surface at the determined orientation at the identified location.

10. The method of claim 9, wherein coupling the object sensor to the mounting bracket comprises threading two fasters through the object sensor into two threaded through openings in the base portion of the mounting bracket, and wherein the base portion comprises three threaded through openings, one of which is not used depending on the determined orientation of the object sensor relative to the mounting bracket.

11. The method of claim 9, further comprising attaching the object sensor to a user interface device through a cable by routing the cable from the object sensor in a direction away from the wall portion.

12. The method of claim 9, wherein the mounting bracket comprises a first wall portion and a second wall portion, each of the first and second wall portions extending from a peripheral side of the base portion of the mounting bracket, and wherein coupling the object sensor to the mounting bracket is performed such that the object sensor is protected by the first and second wall portions against lateral impact from a rear impact guard (RIG) of a trailer approaching the loading dock.

13. The method of claim 9, wherein the object sensor comprises a first sensitivity along a first axis of detection and a second sensitivity along a second axis of detection perpendicular to the first axis of detection, wherein the first sensitivity is less than the second sensitivity, and wherein determining the orientation to couple the object sensor to the mounting bracket is performed such that the first axis is a horizontal axis.

14. The method of claim 9, wherein the object sensor detects presence of a vehicle at the loading dock, and wherein detection signals generated by the object sensor are configured to activate or allow operation of, or deactivate or disallow operation of, one or more equipment at the loading dock.

15. A mounting bracket for coupling an object sensor to a surface at a loading dock, the mounting bracket comprising:
a base portion including a mounting portion to mount the mounting bracket to a surface and a sensor receiving portion;
a first wall portion extending from a first peripheral side of the base portion by a first distance; and
a second wall portion extending from a second peripheral side of the base portion by a second distance, the first peripheral side different than the second peripheral side,
wherein the mounting bracket is mountable to the surface in at least two different orientations with at least one of the first or second wall portions disposed at a vertical elevation above the compartment, wherein the base, the first wall portion, and the second wall portion together define a compartment in which the object sensor is receivable, wherein the compartment is configured to receive the object sensor in at least two orientations, and wherein the first and second distances are greater than a thickness of the received object sensor.

16. The mounting bracket of claim 15, wherein the mounting portion comprises two unthreaded openings, wherein the sensor receiving portion comprises three threaded openings, and wherein only two of the three threaded openings are used to couple the object sensor to the mounting bracket, the used two threaded openings determined based on the orientation of the object sensor with respect to the base portion.

17. The mounting bracket of claim 16, wherein the two unthreaded openings are exposed and accessible from the object sensor when the object sensor is coupled to the mounting bracket.

18. The mounting bracket of claim 17, wherein all three of the three threaded openings are covered by the object sensor when the object sensor is coupled to the mounting bracket.

19. The mounting bracket of claim 18, wherein the first and second peripheral sides of the base portion are consecutively arranged, wherein the base portion further comprises a third peripheral side and a fourth peripheral side, and wherein the third and fourth peripheral sides terminate without wall portions.

20. A loading dock comprising:
a centerline associated with a door of the loading dock;
a dock leveler;
a sidewall surface disposed below the dock leveler; and
the mounting bracket of claim 19 disposed laterally offset from the centerline at a location along the sidewall surface below the dock leveler.
